(19) United States
(12) Patent Application Publication
(10) Pub. No.: US 2002/0004390 A1
(43) Pub. Date: Jan. 10, 2002

(54) Method and system for managing telecommunications services and network interconnections

(76) Inventors: Rory Joseph Cutaia, Dix Hills, NY (US); Peter Barrett Feldman, New York, NY (US); Hunter Patrick Newby, Lido Beach, NY (US); Romelio Alberto Rivera, Fort Lee, NJ (US)

Correspondence Address: O'MELVENY & MYERS LLP, 400 So. Hope Street, Los Angeles, CA, 90071-2899, US

(21) Appl. No.: 09/851,392

(22) Filed: May 7, 2001

Related U.S. Application Data
(60) Provisional application No. 60/202,076, filed on May 5, 2000.
(60) Provisional application No. 60/212,686, filed on Jun. 20, 2000.

(51) Int. Cl. H04Q 7/20

(52) U.S. Cl. 455/424; 455/423; 455/448; 455/414

(57) ABSTRACT

A method and system of managing telecommunication service and network connections in a colocation site is provided. A customer service module communicates with customers regarding at least one telecommunications resource within the colocation site. An engineering module manages provisioning of the telecommunications resource within the colocation site in response to communications with the customers. An MIS module collects information on operation of the telecommunications resource, and reports to the customers based on the collected information. The customer service module receives requests for pre-sales information (e.g., pricing, availability, equipment configuration, and space within the colocation site), receives and processes orders for use of the telecommunications resource, provides customers with account status, and receives requests to terminate use of the telecommunications resource. The engineering module maintains a database reflecting status of all telecommunications resources in the colocation site, including identification of equipment, space availability, capacity, current load, and customer allocation. The engineering module also changes connections between the telecommunications resources, monitors trouble reports reflecting technical problems with the telecommunications resource, and provides technical support in response to the communications with customers. The MIS module maintains an archive of all data and reports generated within the colocation site, including a video record of physical activity within the colocation site.

### RELATED APPLICATION DATA

This application claims priority pursuant to 35 U.S.C. § 119(e) to provisional patent application Ser. No. 60/202,076, filed May 5, 2000, and to provisional patent application Ser. No. 60/212,686, filed Jun. 20, 2000.

### BACKGROUND OF THE INVENTION

1. Field of the Invention

The present invention relates generally to telecommunications systems and services. More specifically, the invention relates to a method and system for managing a colocation facility, or a network of telecommunications colocation facilities, to provide more efficient communications services and network interconnections.

2. Description of Related Art

In recent years, there has been very rapid growth of telecommunications services and systems. Wide assortments of signals (e.g., representing text, data, voice, images, video, etc.) are routinely conducted through various types of communications systems. Such systems include landline telephone, physically networked computers, wireless networks, optical fiber, etc. To the typical end customer placing a telephone call or sending an email message across the Internet, these telecommunications resources are transparent. In reality, however, many separate telecommunications resources distributed across a large geographic area may be utilized to complete these seemingly simple transactions. For example, a call directed to an Internet service provider (ISP) can be initiated from a personal computer (PC), through the PC modem, to a telephone line of a telephone network providing local service (sometimes referred to as a “local telephone loop”). The ISP is also connected to the local telephone loop, which passes on the call to the ISP. Typically, the ISP has multiple connections to the local telephone loop to provide access to the ISP by multiple users at the same time. Then, by connecting through a network access point (NAP), the ISP can establish a connection between the user's PC and the worldwide packet-switched network commonly referred to as the Internet. Similarly, other communication service providers, including communications carriers such as the local telephone loop providers, can connect with other communication service providers to facilitate their operations. Such communication service providers can include the local telephone loop provider, long-haul telephone network providers, and wireless carriers, etc.

Traditionally, telecommunications services were dominated by a small number of telephone companies that controlled virtually all aspects of a telephone call or data transaction. All the signal switching and routing associated with making a telephone call was accomplished using equipment operated and controlled by the telephone companies. With the deregulation of the telecommunications industry, many smaller companies entered the market for the purpose of providing specialized services, such as long distance calling, wireless, and Internet services. As part of this deregulation, the telephone companies were required to provide the new entrants with access to their public service telephone networks (PSTN) so that these services could be provided to their customers. The telephone companies allowed the new service providers to collocate their equipment (e.g., servers, routers, switches, etc.) within the telephone companies' facilities in order to ensure compatibility and reduce signal loss.

Over time, this concept has evolved to the modern colocation facility, in which communications equipment (e.g., racks, cabinets, switches, routers, and other equipment) of different entities are physically positioned at a single geographic location, such as within the same building or the same floor of a building. The colocation facility provides physical space, electrical power, and a link to other communication networks. For example, a web site owner could co-locate its web server with an ISP to which it is connected. In turn, the ISP could co-locate its router with equipment of a provider of switching services. Ports to off-site communication carriers (e.g., C/LEC's (competitive local exchange carriers), IXC's (interexchange carriers), IP Backbones, etc.) (hereafter referred to as “carrier ports”) can also be provided at a colocation facility to provide single-point access to such services by the various co-located equipment. One of the benefits of co-locating can be the reduced length of connectors between two pieces of separately owned and/or operated equipment. This thereby can reduce the cost of the connectors themselves and their installation, and additionally may reduce the probability of losing such connections to damage or severing of the connectors, as well as reduce the labor, material, and service down-time costs of troubleshooting, e.g., replacing such connectors should they become damaged or severed.

In addition to the technical advantages of co-location, this shared arrangement can substantially reduce the cost of providing a telecommunications service. Existing, new and emerging communication service providers often need to deploy equipment in multiple geographic locations or metropolitan areas (e.g., New York, Los Angeles, Chicago, etc.) in a cost-effective and efficient manner. It can be a daunting task to obtain space in carrier buildings in major markets, and the costs associated with obtaining such space are often prohibitive. Co-location allows these service providers to reduce their space requirements and hence their operating cost, thereby enabling more rapid introduction of new services.

Notwithstanding these advantages, there are also drawbacks of conventional colocation facilities. Since the colocation facility typically provides only physical space, electrical power, and network connections, it is entirely up to the service providers that are tenants in the colocation facility to manage, operate and maintain their own equipment. The individual communication service providers typically need to provide administration of their equipment and related services themselves, if it is to be provided at all, and have limited or no access to designing, monitoring, and maintaining their colocated equipment. For many communication service providers it may be difficult, economically or otherwise, to obtain or deploy technical personnel with the requisite level of expertise. It is even more difficult to deploy and manage such personnel twenty-four hours a day, seven days a week. Also, many providers lack a suitably effective way to market their products and services. They may lack knowledgeable salespeople, sales and marketing expertise.

Another drawback of conventional colocation facilities is that their unmanaged nature leads to inefficiencies in the use of resources within the colocation facility. One such inefficiency is that the physical space may not be used in an optimum manner. Generally, the co-located equipment of the same providers or different providers can be connected together or to one or more carrier ports via cross-connects in the form of electrical connectors (e.g., electrical wires or cables) that are physically attached between the applicable equipment and port. The wires typically extend above the co-located equipment, below the co-located equipment (e.g., below a raised floor), or both. These wires therefore take up space within the co-location site that cannot then be used for additional communications equipment. As a result, the colocation facility can provide space to fewer communication service providers, reducing revenue and limiting the services available to co-located communication service providers.

Furthermore, for a given cross-connect, the original connector used will have a single maximum capability (e.g., DS-0, DS-1, DS-3, etc.). If it is necessary to change or re-provision the connection capability, the connector must be physically removed and replaced with a different connector that can provide the newly desired capability. This process can be time, labor and cost intensive, resulting in temporary unavailability of the communications equipment to which the connectors to be replaced are attached, and/or down-time of the services provided between such connected communications equipment. Similarly, if a connector becomes damaged or severed, the connector may need to be replaced, resulting in potentially significant down-time of one of more services of the equipment connected to the damaged or severed connector. The owner and/or operator of communications equipment connected to a damaged or severed connector is typically notified of such damage or severing only after the operation of such communications equipment has been affected. In the worst case, this notification may occur only after customers of the communication provider are affected.

Another significant problem faced by communication service providers is connectivity, e.g., connectivity to local loop providers, other carriers and customers, or to the PSTN. Connectivity can be the lifeline of the service providers' business. Typically, the average wait time to obtain connectivity through the major local loop providers can be between twelve and twenty-two weeks. For many providers, this delay represents lost revenue, lost profits, and in some cases, lost opportunity. In fact, the ability to obtain connectivity in a timely manner, on a reliable basis, as and when needed, can be the difference between success and failure. The colocation facilities do not have any control over this connectivity, and the service providers are generally on their own in negotiating such access.

Another development within the telecommunications industry is the creation of Internet, telecommunication, and data communication exchanges (e.g., Arbinet—the Xchange, Band-X, Rate Exchange, Enron Broadband Services, etc.) that provide a market for buying and selling aspects of network capacity (e.g., bandwidth, minutes, etc.) between and among communications service providers and end users. To provide, obtain, and effect “settlement” of such capacity through such exchanges, the seller and buyer need to be electrically connected through physical interconnections to the exchange. In an effort to maximize reliability and minimize cost, it may be desirable to minimize the length of connectors and minimize the manual nature of provisioning interconnections from the buyer and seller to the exchange. Unfortunately, physical space geographically near the exchange is often limited and may not accommodate all interested buyers and sellers, requiring some or all of such buyers and sellers to incur high installation, operation, and maintenance costs required by longer distance interconnections to an exchange. Additionally, if a buyer or seller desires to change the capabilities of such connections, downtime, labor, and material costs will typically be incurred. Furthermore, if a communication service provider wishes to participate on more than one exchange, these costs are thereby multiplied accordingly.

Therefore, it would be very desirable to provide a method for providing flexible, more reliable management of telecommunications resources within a colocation facility. In particular, it is desired to provide such a method with minimal complexity and maximum efficiency and flexibility. In addition, it would be desirable to provide a method that improves reliability, timing and flexibility of “settlement” (i.e., the provisioning of physical interconnections) and consummation of bandwidth transactions executed pursuant to a telecommunication exchange. Furthermore, it would be desirable to provide a method for providing co-located equipment administration services to their owners and/or operators, and for facilitating design, monitoring, and maintaining of colocated equipment by their owners and/or operators, both within a single colocation facility and across networks of colocation facilities.

### SUMMARY OF THE INVENTION

The present invention overcomes these and other disadvantages of the prior art by enabling the management of telecommunications services within a colocation site having a plurality of disparate telecommunications resources. The invention permits interoperability between and among non-homogenous networks within a colocation site and among multiple colocation sites. Colocation site customers can perform immediate route changes, provide enhanced service features and reports, and view and monitor their own cross-connected network remotely. Different carrier networks can be interconnected within and between colocation sites through an intelligent intra-facility cross-connect capability.

In accordance with an embodiment of the invention, a method and system of managing telecommunications resources and interconnections in a colocation site is provided. A customer service module communicates with customers regarding at least one telecommunications resource within the colocation site. An engineering module manages provisioning of the telecommunications resource within the colocation site in response to communications with the customers. An MIS module collects information on operation of the telecommunications resource, and reports to the customers based on the collected information. The customer service module receives requests for presales information (e.g., pricing, availability, equipment configuration, and space within the colocation site), receives and processes orders for use of the telecommunications resource, provides customers with account status, and receives requests to terminate use of the telecommunications resource. The engineering module maintains a database reflecting status of all telecommunications resources in the colocation site, including identification of equipment, space availability, capacity, current load, and customer allocation. The engineering module also changes connections between the telecommunications resources, monitors trouble reports reflecting technical problems with the telecommunications resource, and provides technical support in response to the communications with customers. The MIS module maintains an archive of all data and reports generated within the colocation site, including a video record of physical activity within the colocation site.

A more complete understanding of the method and system for managing telecommunications services and network interconnections will be afforded to those skilled in the art, as well as a realization of additional advantages and objects thereof, by a consideration of the following detailed description of the preferred embodiments. Reference will be made to the appended sheets of drawings which will first be described briefly.

### BRIEF DESCRIPTION OF THE DRAWINGS

FIG. 1 is a block diagram of an exemplary colocation facility management architecture in accordance with an embodiment of the invention;

FIG. 2 is a flow chart illustrating a process of conducting customer contact management for the exemplary colocation facility management architecture;

FIG. 3 is a flow chart illustrating a process of conducting network engineering/operations management for the exemplary colocation facility management architecture;

FIG. 4 is a flow chart illustrating a process of conducting financial management for the exemplary colocation facility management architecture;

FIG. 5 is a block diagram of a colocation facility management architecture coupled to a plurality of colocation sites in accordance with another embodiment of the invention; and

FIG. 6 is a block diagram of an exemplary intra-facility cross connect management system in accordance with another embodiment of the invention.

### DETAILED DESCRIPTION OF PREFERRED EMBODIMENTS

The present invention satisfies the need for flexible, more reliable management of telecommunications resources within a colocation facility. More particularly, the method and system of the present invention facilitates design, monitoring, and maintaining of colocated equipment by their owners and/or operators, both within a single colocation facility and across networks of colocation facilities. The method and system further enables reliable and flexible settlement and consummation of transactions executed pursuant to a telecommunication exchange. In the detailed description that follows, numerous specific details are set forth in order to provide a thorough understanding of the present invention; however, it will be apparent to persons skilled in the art that the present invention may be practiced without these specific details. In other instances, well-known structures and devices are shown in block diagram form in order to avoid unnecessarily obscuring the present invention. Like element numerals are used to describe like elements illustrated in one or more of the above-described figures.

Generally, the present invention provides a professionally managed, telecommunications colocation facility that facilitates the business and operations of existing and new technology and next generation carriers through the combination of colocated resources and telecommunication services (“colocation service provider”). Unlike conventional colocation facilities, the colocation service provider provides a managed, secure, and maintained facility and resources. Communication service provider customers can access their equipment, including monitoring operational status and availability, through the convenience of a web-based graphical user interface (GUI). Customers can also re-provision equipment, either within a colocation facility or across plural colocation facilities, through the same web-based GUI. The communication service providers may further have access to experienced, high quality technical personnel who are available on-site to service, support and maintain the providers' equipment twenty-four hours a day, seven days a week. The colocation service provider's customers may include incumbent local exchange carriers (ILEC), competitive local exchange carriers (CLEC), competitive access providers (CAP), Internet service providers (ISP), application service providers (ASP), postal, telegraph & telephone companies (PTT), and others.

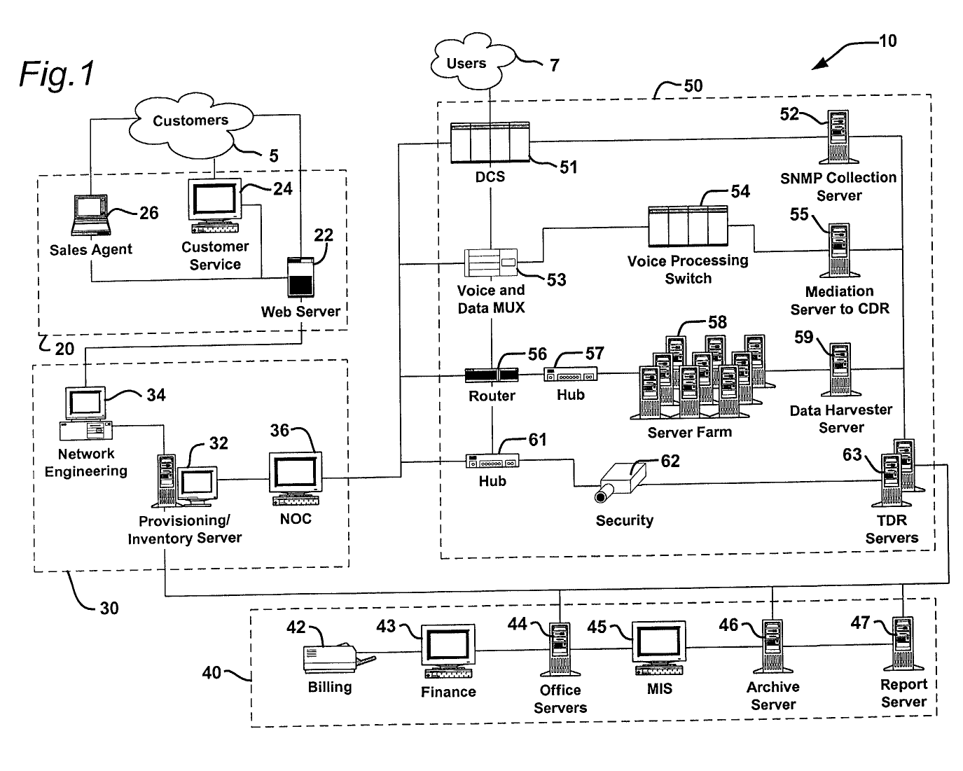

Referring first to FIG. 1, a block diagram of an exemplary colocation facility management architecture 10 is illustrated in accordance with an embodiment of the invention. The colocation facility management architecture 10 includes a sales support module 20, an engineering module 30, a network management information system (MIS) module 40, and a colocation site 50. The sales support module 20 provides an interface with customers to handle pre-sales support, order processing, account management, and account termination. The engineering module 30 provides an interface between the sales support module 20 and the colocation site 50, and manages provisioning of resources within the colocation site, balancing of load placed on co-located resources, and forecasts changes in load and demand on co-located resources. The network MIS module 40 provides tracking and reporting of operations within the colocation site 50 to enable customer billing. Lastly, the colocation site 50 provides a secure environment in which the co-located telecommunications resources are placed. It should be appreciated that each of these elements of the colocation facility management architecture 10 need not be co-located, but rather the elements may dispersed among different physical locations. Moreover, it is anticipated that the colocation facility management architecture 10 include a plurality of colocation sites 50 that are managed to provide network level efficiencies, as will be further described below.

More specifically, the sales support module 20 further comprises a web server 22, a customer service agent 24, and a sales agent 26. The web server 22 is adapted to serve web pages to customers 5 that connect to the sales support module 20 via the Internet. The web server 22 is also connected to the engineering module 30 to obtain current information regarding the status, configuration, and availability of equipment and space within the colocation site 50. The sales agent 26 provides pre-sales information to a prospective customer 5. The customer service agent 24 provides a contact for existing customers for account management, order processing and account termination. Each of the sales agent 26 and the customer service agent 24 can also access the web server 22 in order to obtain current information regarding the colocation site 50. The customer service agent 24 and sales agent 26 are each depicted in FIG. 1 as computer terminals, though it should be appreciated that each of these functions may actually be provided by a plurality of networked computer terminals as commonly known in the art. Each of these functions of the sales support module 20 will be described in further detail below.

It is expected that customers 5 can communicate with the sales support module 20 using a plurality of methods. Customers 5 may communicate with the web server 22 over the Internet using a personal computer equipped with a browser application to obtain presales information regarding the services provided by the colocation site 50, including pricing, availability, network connectivity, etc. Other web enabled devices, such as personal digital assistants (PDAs) and cellular telephones, may also be used to access the web server 22 in the same manner. Alternatively, the customers 5 may communicate with the customer service agent 24 and/or sales agent 26 over the telephone, either with a live agent or through an interactive voice response (IVR) system. Sales agent terminals may be disposed in publicly accessible spaces (e.g., retail establishments, automated teller machines (ATMs), credit card verification terminals, etc.) enabling customers 5 to access support module 20 without a telephone or Internet connection. Customers 5 can also communicate with the customer service agent 24 and/or sales agent 26 via e-mail messages.

The engineering module 30 further comprises a provisioning/inventory server 32, network engineering unit 34, and network operations center (NOC) 36. The provisioning/inventory server 32 maintains a database reflecting the status of the colocation site 50, including an identification of equipment, space availability, capacity, current load, and customer allocation. The provisioning/inventory server 32 is connected to each of the network engineering unit 34 and the NOC 36 to provide access to the database. The network engineering unit 34 provides technical support to the sales support module 20 in responding to customer inquiries, designing solutions for customer requests, and monitoring trouble reports and maintenance issues. The NOC 36 manages the status of the colocation site 50, including provisioning, load balancing, forecasting and maintenance. As above, the network engineering 34 and NOC 36 are each depicted in FIG. 1 as computer terminals, though it should be appreciated that each of these functions may actually be provided by a plurality of networked computer terminals as commonly known in the art. Each of these functions of the engineering module 30 will be described in further detail below.

The MIS module 40 further comprises a billing unit 42, a finance unit 43, MIS office server 44, MIS unit 45, archive server 46 and report server 47. The billing unit 42 generates customer billing reports. The finance unit 43 tracks the status of accounts receivable and payable. The MIS office server 44 runs the network within the MIS module 40 permitting each of the elements to communicate together. The MIS unit 45 integrates data from all the departments it serves and provides operations and management with the information they require. The archive server 46 maintains an archive of all data and reports generated within the colocation facility management architecture 10. The report server 47 collects information from the colocation site 50, such as reflecting the amount of use of co-located resources and services. Detailed records may be obtained containing every event transacted on the network, which is then used to generate billing reports for the customers. As above, the finance unit 43 and MIS unit 45 are each depicted in FIG. 1 as computer terminals, though it should be appreciated that each of these functions may actually be provided by a plurality of networked computer terminals as commonly known in the art. Each of these functions of the MIS module 40 will be described in further detail below.

The colocation site 50 comprises a plurality of different kinds of co-located equipment that provide telecommunications services for users 7. As shown in FIG. 1, the co-located equipment include, but is not limited to, a digital cross-connect (DCS) 51, SNMP collection server 52, a voice and data MUX (multiplexer) 53, a voice processing switch 54, a mediation server 55, a router 56, hubs 57, 61, a server farm 58, a data harvester server 59, a time data report (TDR) server 63, and security cameras 62. The co-located equipment is ordinarily contained within racks that supply electrical power and interconnects to the equipment. The colocation site 50 will typically comprise an environmentally controlled facility in which air temperature and humidity are closely monitored to maintain within proper operating limits of the equipment. The equipment may be supplied by the colocation service provider, or may be supplied by the customer. As discussed above, every rack and item of equipment is identified in the database maintained by the provisioning/inventory server 32 of the engineering module 30. Interconnections between the equipment within the colocation site 50 make take the form of electrical or optical data lines.

Particularly, the DCS 51 is a network device used by telecom carriers and large enterprises to switch and multiplex low-speed voice and data signals onto high-speed lines and vice versa. It is typically used to aggregate several T1 lines into a higher-speed electrical or optical line as well as to distribute signals to various destinations; for example, voice and data traffic may arrive at the cross-connect on the same facility, but be destined for different carriers. Voice traffic would be transmitted out one port, while data traffic goes out another. Users 7 are connected to the colocation site 50 through the DCS 51. The NOC 36 is connected to the DCS 51 through a network connection.

SNMP (Simple Network Management Protocol) is a widely-used network monitoring and control protocol, and the SNMP server 52 collects data passed from SNMP agents, which are hardware and/or software processes reporting activity in each network device (e.g., hub, router, bridge, etc.) to the workstation console used to oversee the network. The agents return information contained in a MIB (Management Information Base), which is a data structure that defines what is obtainable from the device and what can be controlled (turned off, on, etc.).

The voice and data MUX 53 allows voice and data signals to be transported on the same connector. As known in the art, algorithms are used to determine the most efficient level of compression depending on the amount of voice signals. The NOC 36 is connected to the voice and data MUX 53 through a network connection. The voice processing switch 54 processes voice signals to and from the voice and data MUX 53. The router 56 forwards data packets to and from the voice and data MUX 53. Based on routing tables and routing protocols, the router 56 reads the network address in each transmitted frame and makes a decision on how to send it based on the most expedient route (traffic load, line costs, speed, bad lines, etc.). The NOC 36 is connected to the router 56 through a network connection. The mediation server 55 allows communication between each item of equipment connected to the network within the colocation site 50 in their respective native language. The mediation server 55 also performs recording and reporting of telephone calls handled by the voice processing switch 54 used for handling customer billing known as Call Detail Reporting (CDR).

The hubs 57, 61 are central connecting devices that join communications lines together in a star configuration. As known in the art, the hubs 57, 61 may be passive or active. Passive hubs are just connecting units that add nothing to the data passing through them. Active hubs, also called “multiport repeaters,” regenerate the data bits in order to maintain a strong signal, and intelligent hubs provide added functionality. The hub 57 connects the individual servers of the server farm 58 to the router 56, and the hub 61 connects the individual security cameras to the router 56. The NOC 36 is connected to the hub 61 through a network connection.

The server farm 58 is a group of network servers that are housed in one location. The individual network servers, or sub-groups of network servers, might all run the same operating system and applications and use load balancing to distribute the workload between them. Alternatively, the servers may each be running different operating systems and/or applications associated with different customers of the colocation site 50. The data harvester server 59 collects data from the server farm 58 to provide information regarding services provided by the server applications. For example, the data harvester server 59 may collect information regarding the amount of message traffic (i.e., “hits”) on a particular server. The TDR servers 63 collect information from each of the SNMP collection server 52, mediation server 55, and data harvester server 59, which is then provided to the report server 47 of the MIS module 40.

The security cameras 62 are disposed throughout the colocation site 50, and may be trained on rows of racks or individual racks. The video data collected by the security cameras 62 are provided to the TDR servers 63 for archiving. Since physical security of the equipment contained within the colocation site 50 is generally important to the colocation service provider's customers, the security cameras 62 maintain a record of all activity within the colocation site. For example, a customer may be able to view in real time the rack containing their particular equipment, such as using an Internet connection and a browser application. In addition, the NOC 36 may retrieve archived video data showing a particular rack or item of equipment as part of resolving a technical problem experienced with the item of equipment.

It should be appreciated that the arrangement of equipment in the colocation site 50 illustrated in FIG. 1 is merely exemplary, and that the colocation site may include different arrangements and configurations of equipment as generally known in the art. Of particular significance to the present invention, the NOC 36 is connected to the network of equipment within the colocation site 50 to provide real time status of activity within the colocation site. Also, the provisioning/inventory server 32 is adapted to share information with the TDR servers 63, as well as with the MIS module 40, in order to maintain a current inventory of equipment within the colocation site 50. These connections between the engineering module 30, the MIS module 40, and the colocation site 50 may be provided as part of a local area network (LAN) using an Ethernet protocol. Conversely, the engineering module 30, MIS module 40, and colocation site 50 may be separated by great distances, and these connections may be provided as part of a wide area network (WAN) covering a wide geographic area, such as state or country or a metropolitan area network (MAN) covering a city or suburb.

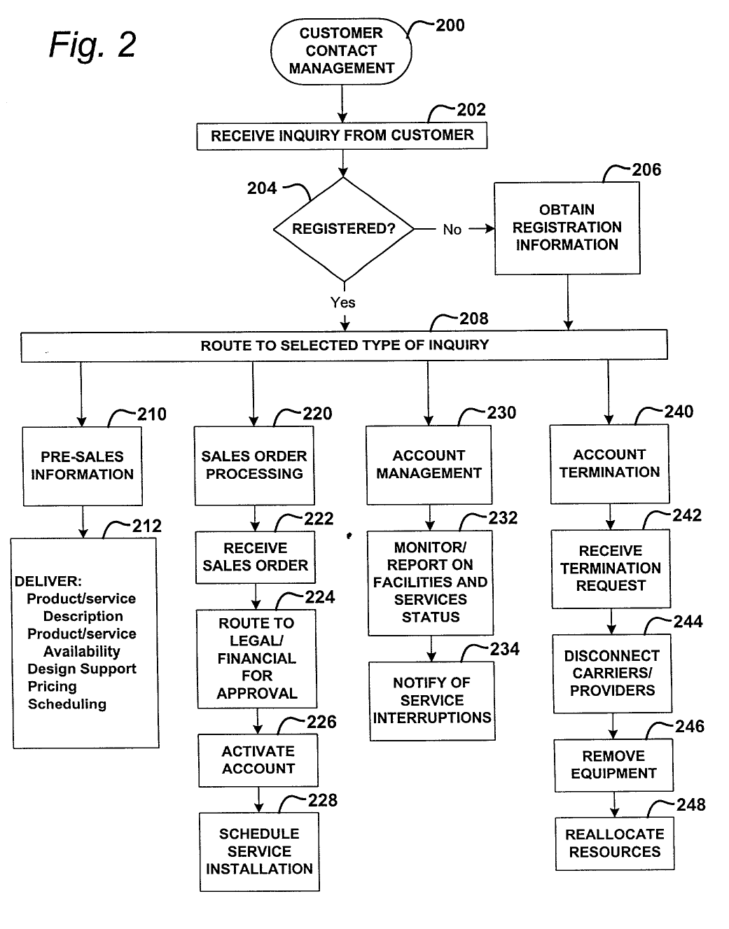

Referring now to FIG. 2, a flow chart illustrates a process of conducting customer contact management 200 for the exemplary colocation facility management architecture. As discussed above with respect to FIG. 1, the sales agent 26 and/or customer service agent 24 perform customer contact management by communicating with the customers 5 via the Internet, telephone/IVR and other media. For example, the web server 22 may deliver pages of information in hypertext markup language (HTML) format from a website associated with the colocation service provider to customers over an Internet connection. It is anticipated that aspects of the exemplary process be implemented in software adapted to execute on computers within the sales support module 20. Other aspects of the process may be performed as part of manual operations conducted by the colocation service provider personnel.

The process begins at step 201 in which an inquiry is received from a customer. As described above, the inquiry may be in the form of accessing an information page on the Internet, a telephone inquiry, an e-mail message, etc. Before, responding to the inquiry, the process will determine at step 204 whether the customer has registered with the colocation service provider. For customers accessing the colocation service provider via an Internet connection, registered customers may have a file loaded on their computer (known as a “cookie”) that identifies to the web server that the customer has previously visited the web site, and the file may further identify the registration information. Alternatively, the customer may be asked to provide a registration number. For customers accessing the colocation service provider via a telephone connection, the IVR system may ask the customer for the registration number, which could then be entered using the keypad of the telephone. Under either method, if the customer has not yet registered, the process will obtain registration information from the customer at step 206. The registration information may include name, company name, business address, phone, e-mail address, etc. The customer may also select a user name and password to be used in subsequent accesses to the website.

Assuming the customer has already registered with the colocation service provider, or after completion of the registration process of step 206, the process passes to step 208 which routes the inquiry according to the type of information being sought. The possible choices include pre-sales information (step 210), sales order processing (step 220), account management (step 230), and account termination (step 240). It should be appreciated that other choices are possible. Moreover, the process may be sufficiently sophisticated to offer only the choices that are appropriate for the customer (e.g., a prospective customer that has not established an account would only be offered pre-sales information). If the customer accesses pre-sales information at step 210, the process delivers an assortment of information at step 212. The information may include product and service descriptions in the form of brochures identifying all equipment provided and supported by the colocation service provider. The product descriptions may further identify the version level supported for each component. A listing of services and packaged solutions may also be provided, ranging from circuit level agreements to custom reports.

In addition to these static information deliveries, the customer may also be able to obtain more customized information by submitting specific inquiries to a sales agent 26. By accessing the database contained on the provisioning/inventory server 32, the sales agent 26 can provide the customer with product availability and capacity information. The database may not only identify available services, but may also project upcoming services and their availability dates. This helps the customer design their solution with assured service delivery. Further, the sales agent 26 can help the customer design a solution tailored to their needs and budget. The design service may also provide prepackaged solutions that have been designed and tested according to industry standard practices. Once the design is complete, the sales agent 26 can provide the customer with resource and equipment requirements as well as pricing and schedule data.

If the customer is ready to place an order, the customer may access sales order processing at step 220. The sales agent 26 at step 222 receives the sales order. The sales order may be submitted in the form of a template that is completed from the website, or may be given directly to the sales agent 26 over the telephone. Once the sales order is received, it may be forwarded to legal and financial departments for review at step 224. For example, the legal department may review the sales order to ensure that proper liability insurance, indemnifications, and remedies are established. It may also be necessary to obtain letters of authorization and releases along with the sales order. The financial department may conduct a financial review of the proposed customer, such as to set up credit levels and establish deposit amounts for the account.

Once approved by the legal and financial departments, the sales order becomes a service level agreement and the customer account is activated at step 226. The customer account is loaded onto the customer database and configured according to system level requirements. The level of access to the network and report parameters for the customer may be determined at this time. Specifically, customers may be able to access the status of their accounts through the website (discussed below), and the access level assigned will determine the amount of detail that the customer will be allowed to view. Access level may further include network access that allows the customer to view account reports and network statistics over the Internet, and security access that gives the customer physical access to the equipment within the colocation site 50. The customers may further be asked to compile an escalation list and alarm triggers that provide the NOC 36 with vital information in the event of an emergency. Lastly, the customer account record may also establish reporting and billing information.

After the account is activated, the service is scheduled for installation at step 228. The sales support module 20 notifies the engineering module 30 of the account activation, which then arranges for the installation, activation and testing of the service. The engineering module 30 also assigns staff and orders equipment necessary to accomplish these tasks. The schedule for these activities is then provided to the customer. During the account activation process, the colocation service provider technical personnel work closely with the customer to install and test the service in accordance with their agreement. All aspects of the service are tested, and everything from network traffic to report generation is checked. Upon completion of the testing, the customer signs off on the job and the service moves into a monitoring mode.

If the customer has already established an account, the customer may access the account management process at step 230. The sales support module 20 can provide the customer with full time (e.g., seven days per week, twenty four hours per day) monitoring of its facilities and services within the colocation site 50. For example, the colocation service provider may employ traffic pattern triggers and telemetry monitoring via SNMP to obtain real time alarm triggers reflecting discrepancies in service. In the event of a problem, the NOC 36 will provide a response appropriate to the customer's service agreement, and the customer will be notified accordingly. Similarly, if a service interruption occurs all affected customers would be notified at step 234. Depending upon the terms of the service level agreement, the colocation service provider may bill such repairs to the customer by notifying the MIS module 40. The NOC 36 can also monitor network performance and issue service predictions and warnings to customers. Any or all of these types of monitoring information may be accessible to the customer at step 232. The NOC 36 and network engineering 34 may also use this information to identify network problems and develop improvements to the network and services. The customer may also be able to access the financial status of the account, such as current billing information.

If the customer wishes to terminate an established account, the customer may access the account termination process at step 240. The service level agreement will generally define the terms and conditions relating to termination of service. The account termination process begins with receipt of a termination request from the customer at step 242. Termination requests will generally be in written form and should be provided with ample time for proper disconnect and removal of associated equipment. For example, the written termination request may be submitted in electronic form such as a template that is filled in through the website or an e-mail message. At step 244, any carriers or service providers assigned to the customer are disconnected. The termination of service should take into account all services associated with the customer's account. Confirmation of carrier disconnect should be obtained in writing. All account configurations should reflect the disconnect status and all data stored within the colocation site 50 by the customer should be removed and archived. It should be appreciated that some of these disconnection tasks may be accomplished by altering the configuration status reflected in the database managed by the provisioning/inventory server 32, while other disconnection tasks require manual operations supervised by the network engineering 34.

After the service is disconnected, customer equipment is removed at step 246.

For security purposes, no equipment should be removed from the colocation site 50 without a written release form issued by the sales support module 20. Such release forms should be accompanied by an inventory list identifying specific equipment to be removed from the colocation site 50. Engineering personnel associated with network engineering 34 would accomplish the actual removal of equipment and would approve an inventory checklist before removed equipment is packed for shipment. The colocation service provider may subject the customer to storage fees if such equipment is not removed from the colocation site 50 within a time allotted by the service level agreement. Once equipment removal is complete, network resources are reallocated at step 248. Such network resources may be reconfigured and returned to the inventory for re-use. The inventory in the database managed by the provisioning/inventory server 32 would be modified to reflect the equipment availability. Supporting equipment may also be refurbished and restored to the inventory for future use.

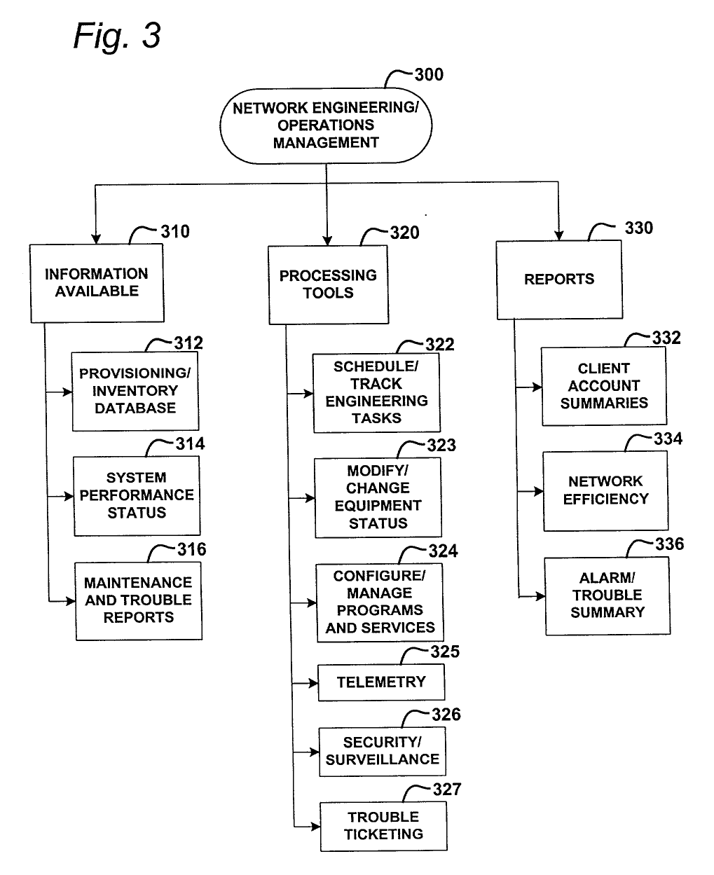

FIG. 3 illustrates a flow chart showing an exemplary process 300 of conducting network engineering/operations management for the colocation site 50. As discussed above, the engineering module 30 and the sales support module 20 work closely together in managing resources within the colocation site 50. The network engineering 34 and NOC 36 have software systems that interact with the database managed by the provisioning/inventory server 32 to manage these network resources. The software systems provide the network engineering personnel with information (step 310), processing tools (step 320), and reports (step 330). The information available to the engineering personnel includes access the database within provisioning/inventory server 32 (step 312), system performance status (step 314), and maintenance and trouble reports (step 316). This gives the network engineering personnel real time information on the configuration and status of all network systems and devices available within the colocation site 50. The performance information is important to support trouble shooting and network maintenance.

Along with this information, the process tools allow the network engineering personnel to affect changes to the status of equipment within the colocation site 50. The processing tools include a scheduling and tracking capability (step 322) that enables the network engineering personnel to create a schedule for implementing all engineering tasks and track that the tasks are completed. An element management tool (step 323) enables the network engineering personnel to modify or change equipment status by altering the database within provisioning/inventory server 32. This element management tool may further trigger the generation of messages to technical staff located within the colocation site 50 to inform or instruct them of such modifications or changes to equipment status. Similarly, an application management tool (step 324) enables the network engineering personnel to configure and manage programs and services provided by the colocation site 50. For example, if a customer wishes to add a caller-ID function to its existing telecommunications service, the network engineering personnel can add this new function using the application management tool. A telemetry monitoring tool (step 325) enables the network engineering personnel to manage network performance and provides alarms reflecting problems with equipment or services within the colocation site 50. A security and surveillance tool (step 326) allows the network engineering personnel to monitor the security within the colocation site 50. This tool may enable selective viewing of live feeds from selected video cameras within the colocation site 50 in order to observe physical activity at an individual rack or row of racks. Additionally, the tool may enable the retrieving of archived video data for a particular camera and a particular date and time. Lastly, the trouble ticketing tool (step 327) provides real time status of failures and problems experienced throughout the network.

The network engineering personnel also have access to reports reflecting the status of equipment within the colocation site 50. Customer account summaries (step 332) reveal customer performance and its impact on network resources. Network efficiency reports (step 334) indicate the efficiency of traffic on the network and can reveal problem areas. Alarm reports and trouble summaries (step 336) pinpoint potential and actual problems across the network. The network engineering personnel may also be able to generate ad-hoc reports in response to queries in order to solve specific problems or monitor unique equipment issues.

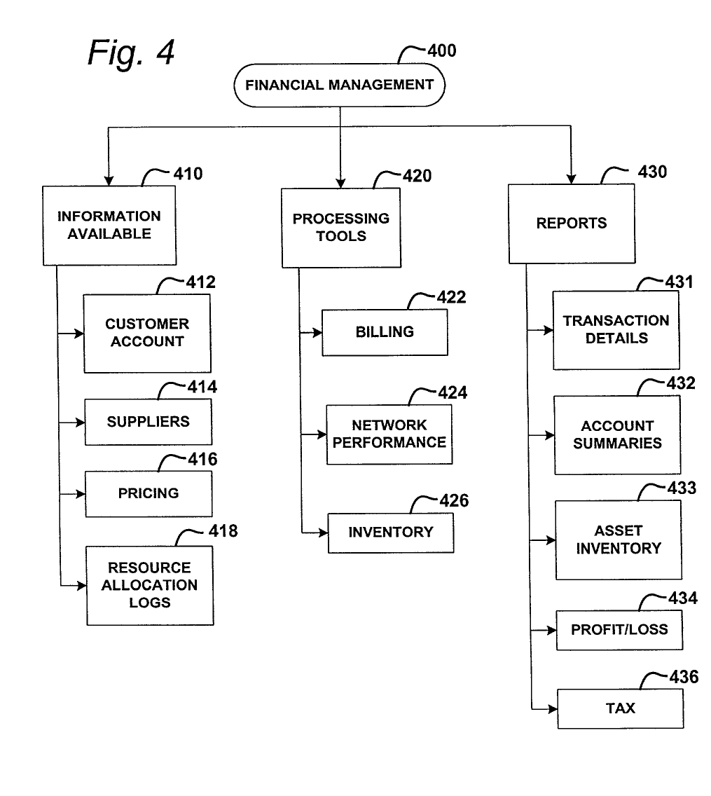

FIG. 4 illustrates a flow chart showing an exemplary process 400 of conducting financial management for the colocation site 50. As discussed above, the MIS module 40, the engineering module 30, and the sales support module 20 communicate information between them to manage the customer accounts and produce billing reports. The finance unit 43 and billing unit 42 have software systems that interact with the database managed by the TDR servers 63 to manage the financial information. The software systems provide the MIS personnel with information (step 410), processing tools (step 420), and reports (step 430). The information available to the MIS personnel includes access to the customer account database (step 412), suppliers database including both service providers and equipment vendors (step 414), pricing database providing an historical record of pricing information for customers and vendors (step 416), and resource allocation logs for billing of services (step 418). The processing tools include billing systems that track customer use (step 422), network performance summaries that establish the efficient use of resources (step 424), and inventory systems that track assets and manage losses (step 426). The reports include transaction detail records that contain every event transacted on the network (step 431), account summary reports identifying customer usage on the network (step 432), asset inventory reports showing resource utilization (step 433), profit/loss reports showing the overall financial state of the colocation service provider (step 434), and tax reports showing the legal compliance of the colocation service provider with tax laws (step 436). Some of these reports may be accessible to the customer, as discussed above.

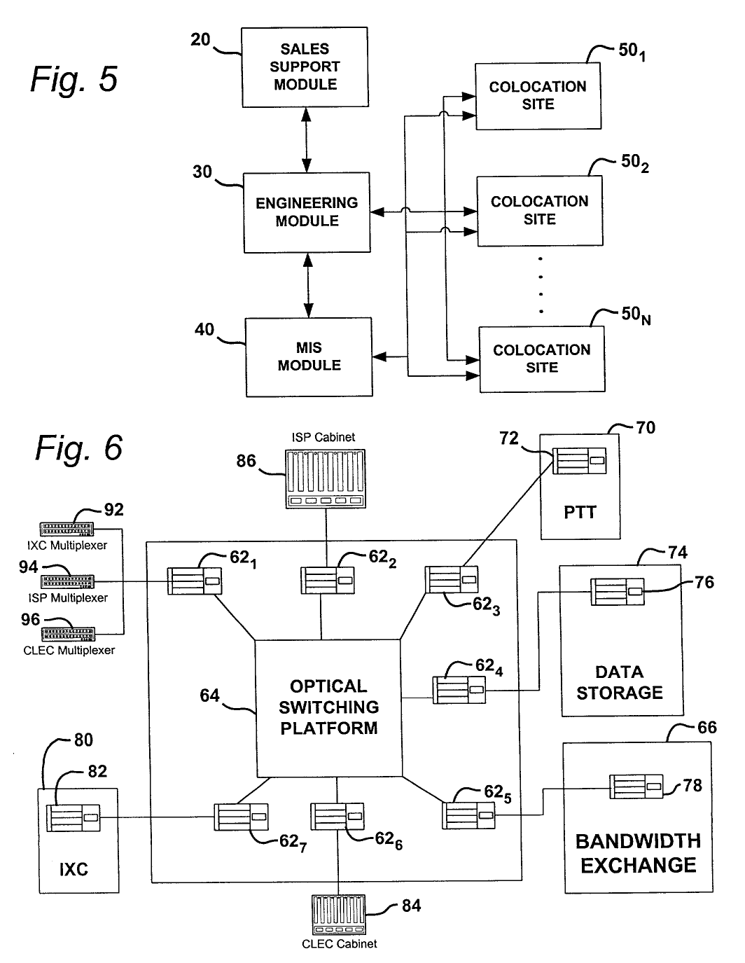

While the foregoing has described a management architecture for a single colocation site, it should be appreciated that the same management architecture could be utilized to manage plural colocation sites. FIG. 5 illustrates an exemplary management architecture for plural colocation sites, including a sales support module 20, engineering module 30, and MIS module 40 substantially as described above. A plurality of colocation sites 50₁-50_{N} are shown, where N can be any integer. The engineering module 30 and MIS module 40 are connected to each of the plural colocation sites 50₁-50_{N} using conventional telecommunication systems. The plural colocation sites 50₁-50_{N} may either be located in a common facility, or may be separated geographically. As described above, the sales support module 20 can provide pre-sales support, order processing, account management, and account termination services for all of the plural colocation sites 50₁-50_{N}. Similarly, the engineering module manages provisioning of resources within each of the colocation sites 50₁-50_{N}, with the provisioning/inventory server 32 maintaining a database of all resources in all colocation sites. The MIS module provides tracking and reporting of operations within the colocation sites 50₁-50_{N}. It should be appreciated that there are additional advantages of managing a plurality of colocation sites 50₁-50_{N} in this manner, such as the ability to shift resources among colocation sites in response to device outages or system failures.

In another aspect of the present invention, service providers such as bandwidth, minute, and broadband exchanges, that do not own their own networks but are facilitators of third party transactions, also have network access to the colocation site 50. Such exchanges introduce buyers and sellers of bandwidth through the exchanges' switch or router for a fee. Such exchanges are also preferably connected to the colocation site 50 by either having their equipment or circuits virtually located or physically located at the colocation site. Communications exchanges for engaging in futures and derivatives trading of network time may also be provided network access to the colocation site. Preferably, communications exchanges are also connected to the colocation site by either having their equipment or circuits virtually located or physically located at the colocation site. Other network operators having network access to the colocation site 50 include switch and router operators, switch and router partition operators, web hosts, content providers, data storage providers, cache providers, and other similar operators. These network operators are also preferably connected to the colocation site 50 by either having their equipment or circuits virtually located or physically located at the colocation site.

Referring to FIG. 6, an exemplary intra-facility cross connect management system is illustrated that can facilitate connections between co-located equipment in satisfaction of such exchange transactions. FIG. 6 shows an optical switching platform 64 having a plurality of optical/electrical distribution panels 62₁-62₇. The optical switching platform 64 is an optical switching device that directs the flow of signals between a plurality of inputs and outputs. The switching platform 64 may be entirely optical, wherein the device maintains a signal as light from input to output. Alternatively, the switching platform may be electro-optical, wherein it converts photons from the input side to electrons internally in order to do the switching and then converts back to photons on the output side. Unlike electronic switches, which are tied to specific data rates, optical switches direct the incoming bitstream to the output port and do not have to be upgraded as line speeds increase. Optical switches may separate signals at different wavelengths and direct them to different ports. The optical/electrical distribution panels 62₁-62₇ are junction points having a plurality of connectors that enable connections to be made between equipment. To form a connection to an item of equipment, a technician will physically connect a cable to the optical switching platform 64 through the optical/electrical distribution panels. Once a given customer's initial connection to the optical switching platform 64 through the optical/electrical distribution panels is established manually within a colocation facility, all subsequent interconnections to other similarly connected customers may be executed electronically through the established connection. It is anticipated that the optical/electrical distribution panels 62₁-62₇ have connectors adapted to receive signals in both an optical and electrical format.

A bandwidth exchange 66 is connected to the optical switching platform. The bandwidth exchange 66 has an associated optical/electrical distribution panel 78 connected to the optical/electrical distribution panel 625. Several other service providers and customers are connected to the optical switching platform 64 through associated ones of the optical/electrical distribution panels 62₁-62₇, including a postal, telegraph & telephone company (PTT) 70, a data storage facility 74, an interexchange carrier (IXC) 80. The PTT 70 is connected to the optical switching platform 64, and has an associated optical/electrical distribution panel 72 connected to the optical/electrical distribution panel 623. The PTT 70 may be located outside of the colocation site 50, or may have some equipment co-located in the site. A data storage facility 74 is also connected to the optical switching platform 64, with an associated optical/electrical distribution panel 76 connected to the optical/electrical distribution panel 624. The data storage facility 74 may generally include a plurality of data storage devices configured as network attached storage (NAS) or a storage area network (SAN) for a web host, carrier farm, data cache, or other application, as generally known in the art. The data storage facility 74 may be located outside of the colocation site 50, or may have some equipment co-located in the site. The IXC 80 is also connected to the optical switching platform 64, with an associated optical/electrical distribution panel 82 connected to the optical/electrical distribution panel 62₇. An IXC is an organization that provides interstate (i.e., long distance) communications services within the U.S. The IXC 80 may be located outside of the colocation site 50, or may have some equipment co-located in the site.

Other services connected to the optical switching platform 64 include an Internet service provider (ISP) cabinet 86 and a competitive local exchange carrier (CLEC) cabinet 84. The ISP cabinet 86 is connected to the optical switching platform 64 through an associated optical/electrical distribution panel 622. The CLEC cabinet 84 is connected to the optical switching platform 64 through an associated optical/electrical distribution panel 62₆. The IXC, ISP and CLEC may have associated multiplexers 92, 94, 96 connected to the optical switching platform 64 through an associated optical/electrical distribution panel 62₁.

In operation, the bandwidth exchange 66 communicates a connection request to the optical switching platform 64 to satisfy an order negotiated on the exchange. For example, an ISP customer may wish to order a certain number of minutes of long distance telecommunications service. The optical switching platform 64 then communicates the request to the IXC 80 and routes signals between the IXC multiplexer 92 and the ISP cabinet 86. In the same manner, the optical switching platform 64 can form connections between any of the services connected thereto, and thereby eliminating the need for technicians to manually form connections between panels within the colocation site whenever it is requested to establish, change or disconnect a service. It should be appreciated that signals can be communicated in either the electrical or optical domain, thereby enabling connections between services that use either format (e.g., electrical to electrical, electrical to optical, and optical to optical).

The colocation service provider is able to benefit all connected network operators of the colocation site by allowing for network Service Level Agreements (SLAs). Because of the guaranteed reliability of the colocation site, network operators can offer SLAs to their customers. Note that in conventional network interconnections in conventional colocation facilities, SLAs cannot be offered because of the inherent instability of the network connections. By having a connection to the colocation site, network operators can now offer their own SLA for their network in conjunction with the colocation service provider's SLA across different networks. Thus, SLAs ensure to network providers guaranteed up time on the colocation site network, and the network operators can now support the quality of service (QOS) provisions in the SLA, thereby guaranteeing QOS delivery to the customer.

Other benefits and advantages of the present invention include fulfilling the need for backbone providers who exchange bandwidth, and bandwidth exchanges who have no networks of their own, to have a network that can provide “real-time” interconnections and solve the “last mile” problem. Because in the present invention, a network operator that is connected to the colocation site can provision his network end-to-end, the connected network operator no longer has to deal with the uncertainty of the local loop. Further, by fulfilling the specific needs of the carrier market, the colocation site allows for carriers in either neutral or non-neutral co-location facilities according to the present invention to conduct real time interconnections. Additionally, the present invention fulfills the need for network operators to be able to provision their network end-to-end within a facility. Note that in conventional systems, provisioning is the greatest problem to delivering service. However, the colocation service provider allows for end-to-end provisioning within one facility.

The invention has been described herein in terms of several specific embodiments. Other embodiments of the invention, including alternatives, modifications, permutations and equivalents of the embodiments described herein, will be apparent to those skilled in the art from consideration of the specification, study of the drawings, and practice of the invention. The specification and drawings are, accordingly, to be regarded in an illustrative rather than a restrictive sense. Thus, the embodiments and specific features described above in the specification and shown in the drawings should be considered exemplary rather than restrictive. The invention is further defined by the following claims.

What is claimed is:

1. A method for managing telecommunications services provided by at least one colocation site each having a plurality of disparate non-homogenous telecommunications resources, the method comprises the steps of:
communicating with customers regarding at least one telecommunications resource within the at least one colocation site;
managing provisioning of said at least one telecommunications resource within the at least one colocation site in response to communications with said customers;
collecting information on operation of said at least one telecommunications resource; and
reporting to said customers based on said collected information.

2. The method of claim 1, wherein said communicating step further comprises receiving requests for pre-sales information including at least one of pricing, availability, equipment configuration, and space within the colocation site.

3. The method of claim 1, wherein said communicating step further comprises receiving an order for use of said at least one telecommunications resource.

4. The method of claim 1, wherein said communicating step further comprises providing said customers with account status.

5. The method of claim 1, wherein said communicating step further comprises receiving a request to terminate use of said at least one telecommunications resource.

6. The method of claim 1, wherein said managing step further comprises maintaining a database reflecting status of all telecommunications resources in said at least one colocation site, said status further including at least one of identification of equipment, space availability, capacity, current load, and customer allocation.

7. The method of claim 1, wherein said managing step further comprises changing connections between said at least one telecommunications resource and at least one other telecommunications resource.

8. The method of claim 1, wherein said managing step further comprises monitoring trouble reports reflecting technical problems with said at least one telecommunications resource.

9. The method of claim 1, wherein said managing step further comprises providing technical support in response to said communications with said customers.

10. The method of claim 1, wherein said managing step further comprises monitoring performance status of said at least one telecommunications resource.

11. The method of claim 1, wherein said managing step further comprises installing equipment provided by said customers within said colocation site.

12. The method of claim 11, wherein said installing step further comprises providing rack space and electrical power for said equipment provided by said customers.

13. The method of claim 1, wherein said collecting step further comprises maintaining an archive of all data and reports generated within the at least one colocation site.

14. The method of claim 1, wherein said collecting step further comprises collecting data in accordance with Simple Network Management Protocol (SNMP) from network devices within the at least one colocation site.

15. The method of claim 1, wherein said collecting step further comprises collecting a video record of physical activity within the at least one colocation site.

16. The method of claim 15, wherein said collecting step further comprises archiving said video record.

17. The method of claim 1, wherein said reporting step further comprises generating billing reports reflecting usage of said at least one telecommunications resource.

18. The method of claim 1, wherein said reporting step further comprises reporting performance status of said at least one telecommunications resource.

19. The method of claim 1, wherein said reporting step further comprises reporting trouble reports reflecting technical problems with said at least one telecommunications resource.

20. The method of claim 1, wherein said managing step further comprises changing connection status of said at least one telecommunications resource in satisfaction of an order negotiated on an exchange.

21. A colocation site management architecture, comprising:
at least one colocation site having a plurality of disparate telecommunications resources;
a customer service module adapted to communicate with customers regarding at least one telecommunications resource within the at least one colocation site;
an engineering module adapted to manage provisioning of said at least one telecommunications resource within the at least one colocation site in response to communications with said customers; and
a management information system (MIS) module adapted to collect information on operation of said at least one telecommunications resource and report to said customers based on said collected information.

22. The colocation site management architecture of claim 21, wherein said customer service module receives requests from said customers for pre-sales information including at least one of pricing, availability, equipment configuration, and space within the colocation site.

23. The colocation site management architecture of claim 21, wherein said customer service module receives orders from said customers for use of said at least one telecommunications resource.

24. The colocation site management architecture of claim 21, wherein said customer service module provides said customers with account status.

25. The colocation site management architecture of claim 21, wherein said customer service module receives from said customers requests to terminate use of said at least one telecommunications resource.

26. The colocation site management architecture of claim 21, wherein said engineering module further comprises a database reflecting status of all telecommunications resources in said at least one colocation site, said status further including at least one of identification of equipment, space availability, capacity, current load, and customer allocation.

27. The colocation site management architecture of claim 21, wherein said engineering module changes connections between said at least one telecommunications resource and at least one other telecommunications resource.

28. The colocation site management architecture of claim 21, wherein said engineering module monitors trouble reports reflecting technical problems with said at least one telecommunications resource.

29. The colocation site management architecture of claim 21, wherein said engineering module provides technical support in response to said communications with said customers.

30. The colocation site management architecture of claim 21, wherein said engineering module monitors performance status of said at least one telecommunications resource.

31. The colocation site management architecture of claim 21, wherein said engineering module installs equipment provided by said customers within said colocation site.

32. The colocation site management architecture of claim 31, wherein said engineering module provides rack space and electrical power for said equipment provided by said customers.

33. The colocation site management architecture of claim 31, wherein said MIS module maintains an archive of all data and reports generated within the at least one colocation site.

34. The colocation site management architecture of claim 31, wherein said MIS module collects data in accordance with Simple Network Management Protocol (SNMP) from network devices within the at least one colocation site.

35. The colocation site management architecture of claim 31, wherein said MIS module collects a video record of physical activity within the at least one colocation site.

36. The colocation site management architecture of claim 35, wherein said MIS module archives said video record.

37. The colocation site management architecture of claim 31, wherein said MIS module generates billing reports reflecting usage of said at least one telecommunications resource.

38. The colocation site management architecture of claim 31, wherein said MIS module reports performance status of said at least one telecommunications resource.

39. The colocation site management architecture of claim 31, wherein said MIS module reports technical problems with said at least one telecommunications resource.

40. The colocation site management architecture of claim 31, wherein engineering module changes connection status of said at least one telecommunications resource in satisfaction of an order negotiated on an exchange.
